(19) United States
(12) Patent Application Publication
(10) Pub. No.: US 2014/0041268 A1
(43) Pub. Date: Feb. 13, 2014

(54) SIGN GUARD

(71) Applicant: PUBLIC SAFETY INDUSTRIES, LLC, San Clemente, CA (US)

(72) Inventors: Benjamin Todd Benumof, San Clemente, CA (US); Richard Edwin Wilson, San Clemente, CA (US)

(73) Assignee: Public Safety Industries, LLC, San Clemente, CA (US)

(21) Appl. No.: 13/707,456

(22) Filed: Dec. 6, 2012

Related U.S. Application Data
(60) Provisional application No. 61/682,638, filed on Aug. 13, 2012.

(51) Int. Cl. G09F 15/00; B23C 3/00

(52) U.S. Cl. CPC G09F 15/0075; B23C 3/00
USPC 40/607.11; 264/279; 409/131

(57) ABSTRACT

A sign guard for protecting pedestrians and pets from sharp edges of a sign is disclosed. The sign guard may have a recess within which the sign is received. The recess may be sufficiently deep to cover the sharp edges of the sign to mitigate injury to pedestrians and pets. The sign guard may have a through hole for lightening the weight of the sign guard as well as relieving stress to prevent warpage during certain manufacturing techniques. Additionally, the sign guard may have two (2) mounting pads which protrude inwardly into the through hole for mounting the sign and sign guard to a post. Holes may be drilled or preformed in the mounting pads that line up to the mounting holes of the sign.

### CROSS REFERENCE TO RELATED APPLICATIONS

This application claims the benefits of U.S. Prov. Pat App. Ser. No. 61/682,638, filed on Aug. 13, 2012, the entire contents of which are expressly incorporated herein by reference.

### STATEMENT RE: FEDERALLY SPONSORED RESEARCH/DEVELOPMENT

Not Applicable

### BACKGROUND

The various embodiments disclosed herein relate to a guard for protecting pedestrians and pets from sharp edges of a publicly accessible sign.

Signs are used in publicly accessible areas to direct traffic, provide warning, provide instructions and other uses. In order for those signs to be effective, the signs should be visible and are typically vertically positioned at seven feet but are often vertically positioned below and above this height. During normal pedestrian traffic, pedestrians and pets may come into contact with the sign. By way of example and not limitation, signs are placed in parking lots, biking trails, hiking trails, sidewalks, common areas for meetings and other locations. Pedestrians and pets traverse the area and may come into close proximity with the sign. Due to manufacturing techniques and sign designs, signs that have sharp edges thereby pose a public safety hazard.

Accordingly, there is a need in the art for a device and method to protect pedestrians and pets from injury from publicly accessible signs.

### BRIEF SUMMARY

In an aspect, a guard for protecting pedestrians from a sign having a sharp outer perimeter is disclosed. The guard may comprise a body, a post, and at least one fastener. The body may have a flat sheet configuration. An outer perimeter of the body may be larger than the outer perimeter of the sign. The body may have a recess disposed at a central portion of the body. The recess may define a lower surface and a side surface. The side surface may have the same configuration as the outer perimeter of the sign and may be sized to be slightly larger than the outer perimeter of the sign. The lower surface may contact a back surface of the sign to regulate an insertion distance of the sign into the recess. The lower surface also has a through hole for reducing weight and stress relieving. The post is used to mount the sign and the body at a height visible to pedestrians. The at least one fastener may be secured to the sign and the lower surface of the recess or mounting pad.

The sign may be received into the recess of the body with the sharp outer perimeter of the sign covered by the side surface of the recess. A back surface of the sign may contact the lower surface of the recess. The fastener may be used to mount the sign and the body to the post. The fastener may penetrate the lower surface of the recess.

A depth of the side surface may be equal to or greater than a thickness of the sign.

The side surface of the recess may have a circular configuration, square configuration, diamond configuration or hexagonal configuration.

The lower surface of the recess may form at least one mounting pad protruding inwardly into the through hole for mounting the body of the sign guard to the sign.

In another aspect, a method of manufacturing a guard for a sign is disclosed. The method may comprise the steps of providing a multi layer polyethylene sheet; milling a recess in the polyethylene sheet defining a side surface and a lower surface; and milling a through hole in the lower surface for relieving stress between layers of the multi-layer polyethylene sheet to mitigate warping.

The milling the recess step may include the step of milling the recess to a depth equal to or greater than a thickness of the sign.

The method may further comprise the step of milling two mourning pads extending inwardly into the through hole for mounting the sign and the guard to a post.

In another aspect, a method of manufacturing a guard for a sign is disclosed. The method may comprise the steps of providing a mold having a cavity to form a body having a flat sheet configuration, an outer perimeter of the body being larger than the outer perimeter of the sign, the body having a recess disposed at a central portion of the body, the recess defined by a lower surface and a side surface, the side surface having the same configuration as the outer perimeter of the sign and sized to be slightly larger than the outer perimeter of the sign, the lower surface contacting a back surface of the sign, the lower surface further having a through hole; mounting the mold to an injection molding machine; and injecting injectable material into the injection molding machine to form the guard.

The injectable material may be plastic, polymer, thermoplastic, thermoset or elastomer.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a prior art sign vertically positioned with a post;

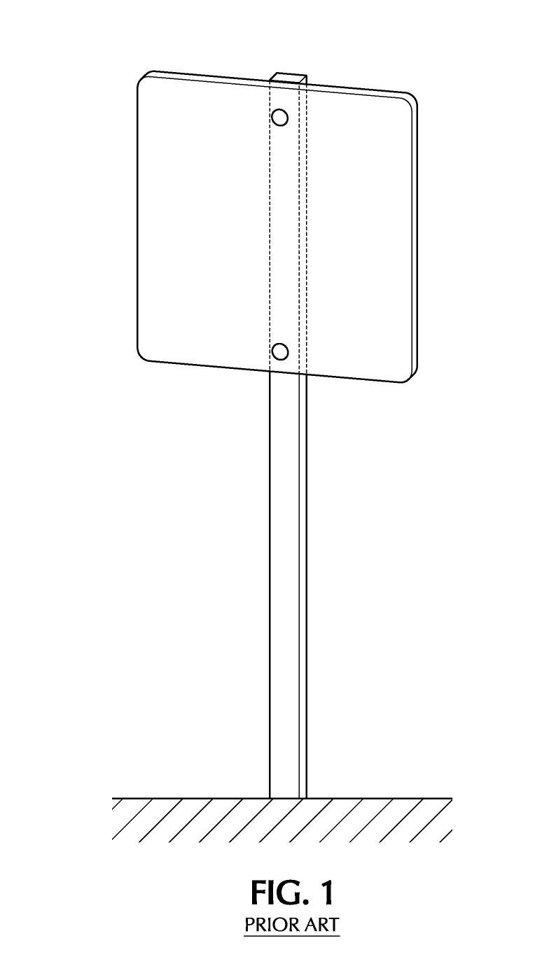

FIG. 2 is an exploded perspective view of a sign guard for protecting pedestrians from sharp edges of the sign; and

FIG. 3 is a cross-sectional view of the sign guard shown in FIG. 2.

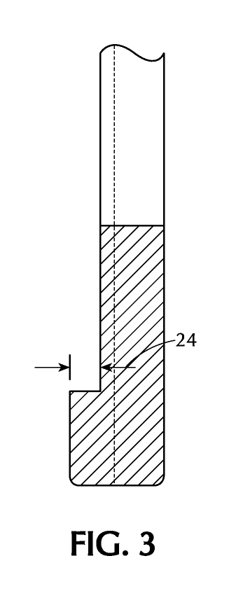

### DETAILED DESCRIPTION

Referring now to the drawings, a sign guard 10 for protecting pedestrians and pets from sharp edges 12 of the sign 14 is shown. The sign guard 10 may have an outer perimeter 16 which has a footprint larger than a footprint of an outer perimeter 18 of the sign 14. The sign guard 10 may have a recess 20 for receiving the sign 14. The recess 20 is smaller than the outer perimeter 16 of the sign guard 10. Moreover, the recess may have a side surface 22 having a configuration that matches the configuration of the outer perimeter 18 of the sign 14. A depth 24 of the recess 20 may be equal to or greater than a thickness 26 of the sign 14. The recess 20 may also define a lower surface 28 that contacts a backside of the sign 14. In this manner, the sign 14 is received into the recess 20. Also, the sharp edges 12 are covered by the border 30. The outer perimeter 16 of the sign guard 10 may have rounded edges or other non-abrasive configuration so that pedestrians and pets will not be cut by the sign guard 10 in the event that the pedestrian or pet inadvertently bumps into the sign guard 10. Importantly, the border 30 of the sign guard 10 prevents the pedestrian or pet from being cut from the sharp edges 12 of the sign 14.

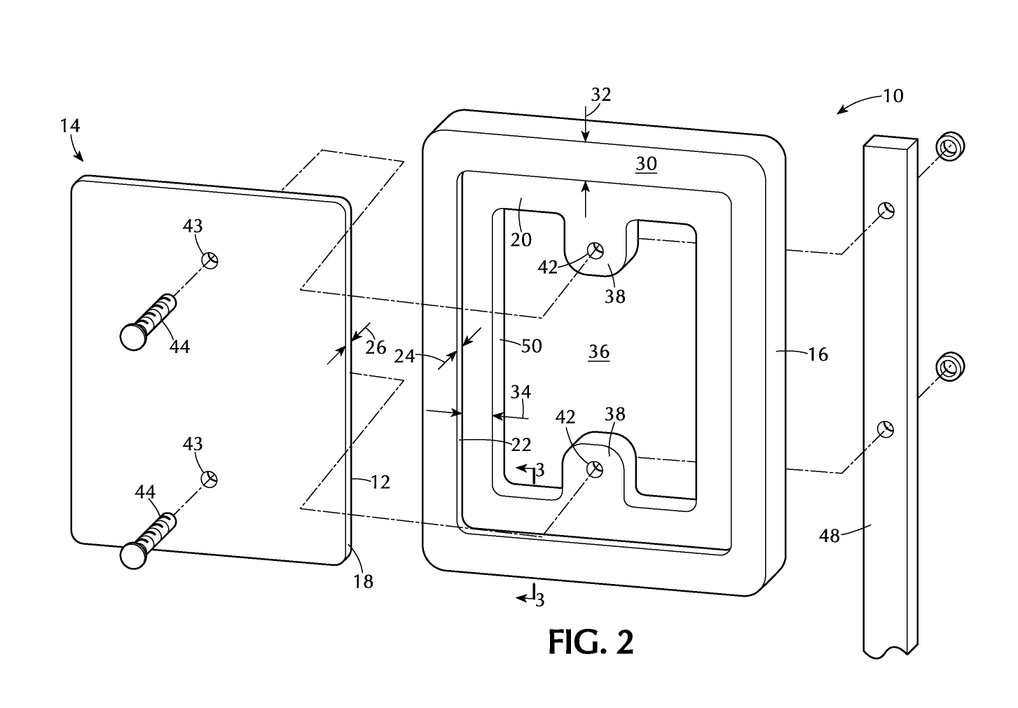

More particularly, referring now to FIG. 2, the sign guard 10 may have a border 30 that protects pedestrians and pets from the sharp edges 12 of the sign 14 by covering the sharp edges 12 and preventing pedestrians and pets from contacting the sharp edges 12 of the sign. The border 30 may have a thickness 32 that mitigate contact between the sharp edges 12 of the sign 14 and the pedestrians or pets. The thickness 32 may be ⅛ of an inch thick to 5 inches or more. The thickness 32 may be uniform about the perimeter to preserve the perimeter shape of the sign 14. In the example shown in FIG. 2, the sign 14 has a rectangular shape. Moreover, the recess 20 has a rectangular shape and the outer perimeter 16 of the sign guard 10 also has a rectangular shape. In this instance, the rectangular shape of the sign 14 is preserved. For stop signs which have a hexagonal configuration, the order perimeter 16 of the sign guard 10 may also have a hexagonal configuration to preserve the intended meaning of the hexagonally shaped stop sign 14. Although the thickness 32 of the border 30 of the sign guard 10 is shown and described as being consistent around the entire perimeter of the sign guard 10, it is also contemplated that the outer perimeter 16 of the sign guard 10 may have other configurations such as wavy, rectangular, etc. Moreover, the outer perimeter 16 of the sign guard 10 may have a different configuration compared to the outer perimeter 18 of the sign 14. By way of example and not limitation, the outer perimeter 18 of the sign 14 may be rectangular, whereas, the outer perimeter 16 of the sign guard 10 may be circular.

The border 30 is defined by the outer perimeter 16 of the sign guard 10 and a side surface 22 defined by the recess 20 which receives the sign 14. The recess 20 may be formed to have a depth 24 equal to or greater than a thickness 26 of the sign 14 to ensure that the border 30 sufficiently covers the sharp edges 12 of the sign 14. However, it is also contemplated that the depth 24 of the recess 20 maybe smaller than the thickness 26 of the sign 14. In this instance, the sign guard 10 still protects pedestrians and pets from lacerations from the sharp edges 12 of the sign 14 since the border 30 prevents the pedestrian and pet from contacting the sharp edges 12 of the sign 14. The sharp edges 12 are juxtaposed to the side surface 22 of the sign guard's recess 20. Preferably, the depth 24 is equal to or greater than the thickness 26 of the sign 14 so that the sharp edges 12 of the sign 14 are recessed into the sign guard 10 and prevent lacerations and injury to pedestrians and pets even though the pedestrians and pets may graze the front of the sign 14 and sign guard 10.

The recess 20 may also be defined by a lower surface 28 which contacts the backside of the sign 14. The lower surface 28 regulates the insertion distance of the sign 14 into the recess 20. The lower surface 28 may also have a thickness 34. The thickness 34 may be equidistant about the entire perimeter of the sign guard 10. However, if is also contemplated that the lower surface 28 maybe a plurality of tabs that extend inward and regulate the insertion distance of the sign 14 into the recess 20. The thickness 34 may be ⅛ inch or more.

A through hole 36 is formed in the lower surface 28. The through hole 36 may be formed for the purposes of lightening the sign guard 10 as well as relieving stress to mitigate warpage during certain manufacturing techniques, as discussed below. The lower surface 28 may also form at least one mounting pad 38. In the drawings, two mounting pads 38 are shown. These mounting pads 38 are disposed on opposed sides of the through hole 36. The mounting pads 38 may extend inwardly as shown in FIG. 2. However, it is also contemplated that the mounting pads 38 may be formed directly on the lower surface 28 immediately adjacent to the side surface 22. The formation and position of the mounting pads 38 depend on how the sign 14 is mounted to the post 40.

The mounting pads 38 are shown as being disposed one above the other in FIG. 2. However, the mounting pad 30 may be positioned anywhere about the inner periphery of the through hole 37. By way of example and not limitation, the mounting pads 38 may be positioned horizontally across from each other instead of vertically as shown. Moreover, the mounting pads 38 may have a through hole 42 for receiving screws 44 to mount the sign 14 and sign guard 10 to the post 48. These through holes 42 may be aligned to the through holes 43 of the sign 14 used to mount the sign 14 to the post 48. These through holes 42 formed in the mounting pads 38 of the sign guard 10 may be formed in the following manner. Initially, the mounting pads 38 are provided without through holes 42. The installer may lay the sign 14 into the recess 20 of the sign guard 10. The installer may mark the location of the through holes 42 and drill the through holes 42 for the purposes of mounting. Alternatively, the sign guard 10 may have predrilled holes 42 fitted to a particular sign 14. These predrilled holes 44 may be aligned somewhere on the mounting pads 38.

The sign guard 10 may be manufactured from a variety of materials including but not limited to a multilayer polyethylene material or an injection molding material. To manufacture the sign guard 10 from a multilayer polyethylene material, a sheet of the multi-layer polyethylene material is provided. The multilayer polyethylene sheet may be cut to size by one of the plurality of different manufacturing methods including but not limited to milling and CNC (computer numerical controlled) machining. As the multilayer polyethylene sheet is being cut by the machine, the stresses between the layers of polyethylene are being redistributed and may cause the multilayer polyethylene sheet to warp. By providing the through hole 36, this redistribute the stress so that the border 30 and the lower surface 28 remain flat so that the lower surface can receive the sign 14. The CNC machine may cut the outer perimeter 16 to size then cut the recess 20 including but not limited to the side surface 22 and the lower surface 28 as well as the inner perimeter 50 of the through hole 36.

If is also contemplated that the sign guard may be manufactured by injection molding Techniques. In particular, a mold having a negative cavity for forming the sign guard 10 shown in FIG. 2 is provided. The mold is mounted to an injection molding machine. Injectable material is flowed into the injection molding machine and allowed to take the shape of the negative cavity of the mold.

The above description is given by way of example, and not limitation. Given the above disclosure, one skilled in the art could devise variations that are within the scope and spirit of the invention disclosed herein, including various ways of configuring the overall shape. Further, the various features of the embodiments disclosed herein can be used alone, or in varying combinations with each other and are not intended to be limited to the specific combination described herein. Thus, the scope of the claims is not to be limited by the illustrated embodiments.

1. A guard for a sign having a sharp outer perimeter, the guard comprising:
a body having a flat sheet configuration, an outer perimeter of the body being larger than the outer perimeter of the sign, the body having a recess disposed at a central portion of the body, the recess defined by a lower surface and a side surface, the side surface having the same configuration as the outer perimeter of the sign and sized to be slightly larger than the outer perimeter of the sign, the lower surface contacting a back surface of the sign, the lower surface further having a through hole;
a post for mounting the sign and the body at a height visible to pedestrians;
at least one fastener securable to the sign and the lower surface of the recess;
wherein the sign is received into the recess of the body with the sharp outer perimeter of the sign covered by the side surface of the recess and a back surface of the sign contacts the lower surface of the recess, the fastener being used to mount the sign and the body to the post through the lower surface of the recess.

2. The guard of claim 1 wherein a depth of the side surface is equal to or greater than a thickness of the sign.

3. The guard of claim 1 wherein the side surface of the recess has a circular configuration, square configuration, diamond configuration or hexagonal configuration.

4. The guard of claim 1 wherein the lower surface of the recess forms at least one mounting pad protruding inwardly into the through hole for mounting the body to the sign.

5. A method of manufacturing a guard for a sign, the method comprising the steps of:
providing a multi layer polyethylene sheet;
milling a recess in the polyethylene sheet defining a side surface and a lower surface;
milling a through hole in the lower surface for relieving stress between layers of the multi-layer polyethylene sheet.

6. The method of claim 5 wherein the milling the recess step includes the step of milling the recess to a depth equal to or greater than a thickness of the sign.

7. The method of claim 5 further comprising the step of milling two mounting pads extending inwardly into the through hole for mounting the sign and the guard to a post.

8. A method of manufacturing a guard for a sign, the method comprising the steps of:
providing a mold having a cavity to form a body having a flat sheet configuration, an outer perimeter of the body being larger than the outer perimeter of the sign, the body having a recess disposed at a central portion of the body, the recess defined by a lower surface and a side surface, the side surface having the same configuration as the outer perimeter of the sign and sized to be slightly larger than the outer perimeter of the sign, the lower surface contacting a back surface of the sign, the lower surface further having a through hole;
mounting the mold to an injection molding machine;
injecting injectable material into the injection molding machine to form the guard.

9. The method of claim 8 wherein the injectable material is a plastic, polymer, thermoplastic, thermoset or elastomer.
